(19) United States
(12) Patent Application Publication
(10) Pub. No.: US 2017/0273841 A1
(43) Pub. Date: Sep. 28, 2017

(54) Mobility Device for Easy Transfer of Physically Challenged Individuals and Methods of Use

(71) Applicant: Richard Maidens, Moundsville, WV (US)

(72) Inventor: Richard Maidens, Moundsville, WV (US)

(21) Appl. No.: 15/464,379

(22) Filed: Mar. 21, 2017

Related U.S. Application Data
(60) Provisional application No. 62/311,701, filed on Mar. 22, 2016.

(51) Int. Cl. A61G 5/14; A61G 5/00; A61G 7/10

(52) U.S. Cl. CPC A61G 5/14; A61G 7/1038; A61G 5/00; A61G 7/1034

(57) ABSTRACT

The present invention provides a mobility device and methods of use to easily and quickly transfer a physically challenged individual from one seat to another seat. The mobility device and methods of use of the present invention also facilitates moving the physically challenged individual from one seat located at one location to another seat located at another location.

### CROSS REFERENCE TO RELATED APPLICATIONS

The present application claims priority to U.S. Provisional Application No. 62/311,701, filed Mar. 22, 2016, which is incorporated herein by reference in its entirety.

### FIELD OF THE INVENTION

The present invention relates to mobility devices and, in particular, to a device for easily moving a physically challenged individual from one seat to another seat, and to facilitate moving the physically challenged individual from one location to another location.

### BACKGROUND OF THE INVENTION

Individuals who are physically challenged due to illness or injury and are confined to a wheelchair often experience difficulty moving from their wheelchair to another seat, such as a chair, lift chair, couch or bed. Oftentimes, it is necessary for one or more caregivers to physically assist and/or carry the individual from one seat to the other, which at best can be cumbersome and at worst can pose a danger to the individual and/or caregiver if the individual or caregiver stumbles or falls down. Currently, there is no device which allows a physically challenged individual to easily and quickly be transferred from one seat to another seat without risk of injury to the individual or their caregiver. There exists a need, therefore, for a device and method to easily and quickly transfer a physically challenged individual from one seat to another seat and from one location to another location.

### SUMMARY OF THE INVENTION

The present invention fulfills this need by providing a mobility device for transferring a physically challenged individual from one seat to another seat, and for easily moving the physically challenged individual from one location to another location.

In an aspect of the invention, there is provided a mobility device comprising a base having a first end and a second end; a plurality of wheels attached to the second end of the base; a ball bearing assembly positioned atop the base, the ball bearing assembly comprised of a stationary section, a rotatable section and a middle section, the middle section containing a plurality of ball bearings therein, the stationary section attached to the base; a rotatable platform positioned atop the ball bearing assembly, the rotatable platform attached to the rotatable section of the ball bearing assembly; a flange positioned atop the rotatable platform and located at one end of the rotatable platform; a toggle clamp positioned atop the rotatable platform and located adjacent to the flange; a hollow vertical pole having a first end and a second end, the second end of the hollow vertical pole configured to fit into the flange; and a horizontal handlebar having a center extension pole, said center extension pole configured to fit into the first end of the hollow vertical pole.

The mobility device includes a hand grip opening adjacent to the first end of the base, and plurality of wheels at the second end of the base.

The rotatable platform includes a traction means located at an opposite end from the flange and the toggle clamp.

In another aspect of the invention, there is provided a method of transferring a physically challenged individual from one seat to another seat using the mobility device described above. The method comprises rotating the rotatable platform so that the traction means is facing towards an individual sitting or reclining on a first seat; placing the toggle clamp in a clamped position to lock the rotatable platform in place; placing each foot of the individual on the traction means of the rotatable platform; placing each hand of the individual on the horizontal handlebar; raising the individual up from the first seat; placing the toggle clamp in an unclamped position to unlock the rotatable platform so that it is able to rotate; rotating the rotatable platform so that the individual is facing away from a second seat located adjacent to the first seat; and lowering the individual onto the second seat.

In a further aspect of the invention, there is provided a method of transferring a physically challenged individual from one or more seats at one location to one or more seats in another location using the mobility device described above. The method comprises rotating the rotatable platform so that the traction means is facing towards an individual sitting or reclining on the first seat located at a first location; placing the toggle clamp in the clamped position to lock the rotatable platform in place; placing each foot of the individual on the traction means of the rotatable platform; placing each hand of the individual on the horizontal handlebar; raising the individual up from the first seat; placing the toggle clamp in an unclamped position to unlock the rotatable platform so that it is able to rotate; rotating the rotatable platform so that the individual is facing away from a seat of an ambulatory device; lowering the individual onto the seat of the ambulatory device; moving the individual adjacent to a second seat located at a second location using the ambulatory device; placing the toggle clamp in a clamped position to lock the rotatable platform in place; having a second individual move the device from the first location to the second location and positioning the device adjacent to the ambulatory device; placing each foot of the individual on the traction means of the rotatable platform; placing each hand of the individual on the horizontal handlebar; raising the individual from the seat of the ambulatory device; placing the toggle clamp in an unclamped position to unlock the rotatable platform so that it is able to rotate; rotating the rotatable platform so that the individual is facing away from the second seat; and lowering the individual from the rotatable platform onto the second seat.

### BRIEF DESCRIPTION OF THE DRAWINGS

A fuller understanding of the invention can be gained from the following description when read in conjunction with the accompanying figures, where like reference numerals refer to identical or functionally similar elements throughout the separate views, which illustrate some, but not the only and exclusive, examples of embodiments of the invention and, as such, the figures disclosed herein are to be considered illustrative rather than limiting. In the drawings:

FIG. 1 is a perspective view of the mobility device with the hollow vertical pole attached to the base;

FIG. 2 is a perspective view of the mobility device without the hollow vertical pole attached; and

FIG. 3 in a front plan view of the ball bearing assembly of the mobility device.

### DETAILED DESCRIPTION OF THE INVENTION

As used herein, the terms “a,” “an,” and “the” in the context of describing the invention and in the appended claims are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

As used herein, the term “seat” is meant to refer to a chair, a recliner, a couch, a divan, a bed, a lift chair, an ambulatory device, such as a wheelchair, and any other type of furniture or structure on which an individual can sit or recline upon.

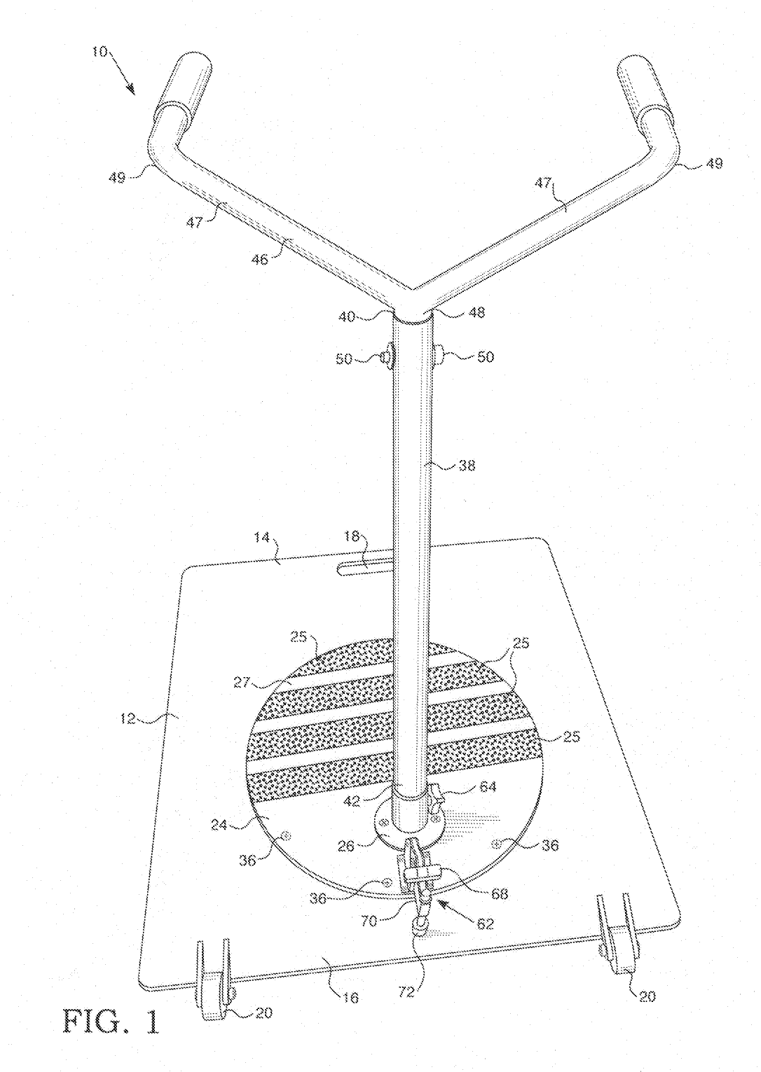

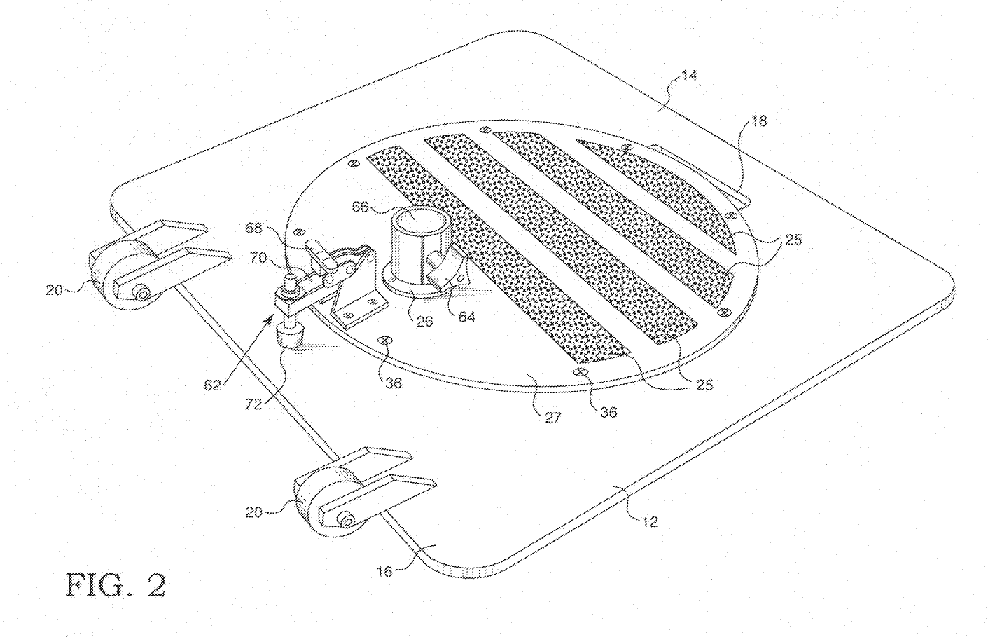

Referring now to FIGS. 1-2, in one embodiment of the invention, there is provided a mobility device 10 comprising a base 12 having a first end 14 and a second end 16. Adjacent to the first end 14 of the base 12 is a hand grip opening 18 for placing the fingers of an individual in the opening in order to hold onto the device 10 with his/her hand so that the device 10 can be pushed or pulled from one location to another location. The second end 16 of the base 12 has a plurality of wheels 20 attached thereto so that the device 10 can be pushed or pulled on its wheels easily from one location to another. In an embodiment, the device 10 has two wheels 20. A rotatable platform 24 is positioned atop the base 12. In an embodiment, the rotatable platform 24 is circular in shape. The rotatable platform 24 has a traction means 25 thereon at one end. Any suitable traction material may be used for the traction means 25, such as, without limitation, non-slip traction safety tape, rubber runners and the like.

As best seen in FIG. 2, positioned atop the rotatable platform 24 at an opposite end from the traction means 25 is a circumferential flange 26 having an opening therein 66. The flange 26 has inserted into its circumferential surface a knob with threaded stud 64. Any suitable flange 26 may be used in accordance with embodiments of the invention, so long as the opening 66 of the flange 66 has a diameter which can accommodate a pole inserted therein, described in detail below.

Positioned also atop the rotatable platform 24 and located adjacent to the flange 26 and nearer to the end of the base 12 is a toggle clamp 62. The toggle clamp 62 is comprised of an arm 68, a handle 70 and a spindle 72. When the toggle clamp is placed in the clamped, or closed, position by moving the arm 68 so that the spindle 72 is pressed tightly atop the base 12, the rotatable platform 24 is locked in place to prevent its rotations. Any suitable toggle clamp 62 may be used in accordance with embodiments of the invention, such as horizontal or vertical handle, manual hold down toggle clamps, having a holding capacity ranging from about 50 pounds to about 500 pounds.

Referring again to FIG. 1-2, a hollow vertical pole 38 having a first end 40, a second end 42, an inner section 47 and an outer section 49, is inserted at its second end 42 into the opening 66 of the flange 26. The knob with threaded stud 64 can be tightened to secure the hollow vertical pole 38 within the flange 26. A horizontal handlebar 46 having a center extension pole 48 is attached to the hollow vertical pole 38 by inserting the center extension pole 48 into the first end 40 of the hollow vertical pole 38. The height of the handlebar 46 thus may be adjusted by raising and lowering the center extension pole 48 within the hollow vertical pole 38. In an embodiment, the handlebar 46 is secured at a desired height by tightening one or more pole knobs with threaded stud 50 located near the first end 40 of the hollow vertical pole 38 (shown in FIG. 1). In another embodiment, the hollow vertical pole 38 and the center extension pole 48 each have a plurality of openings on their surface (not shown). One of the plurality of openings on the center extension pole 48 may be aligned with one of the plurality of openings in the hollow vertical pole, so that a metal fastener pin can be inserted into the aligned openings, thus securing the center extension pole 48 in the handlebar 46 as a desired height.

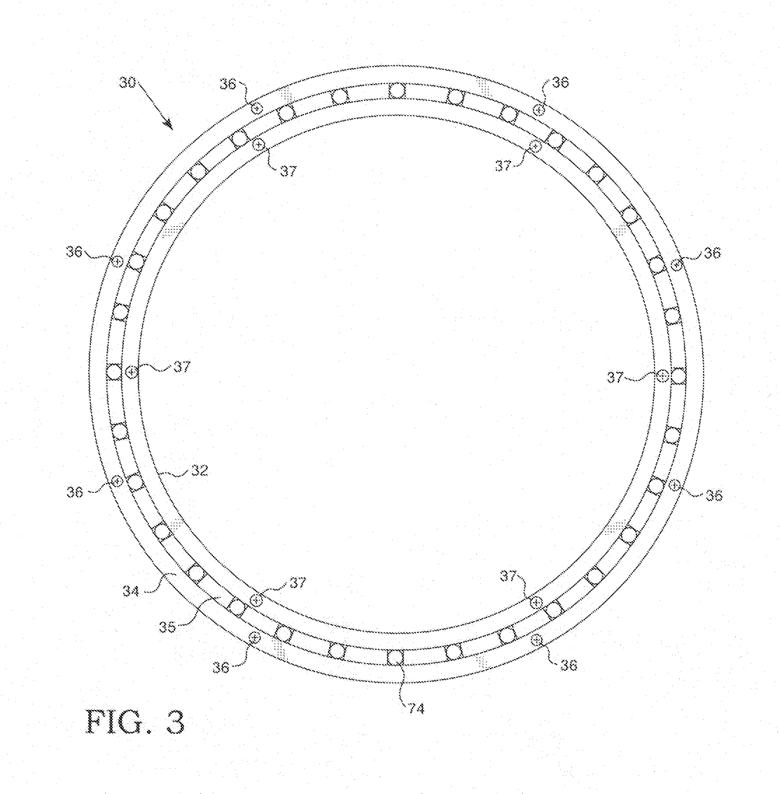

Positioned atop the base 12 of the device 10 and underneath the rotatable platform 24 is a ball bearing assembly 30, shown in FIG. 3. The ball bearing assembly 30 includes a stationary inner section 32, a rotatable outer section 34 and a middle section 35 that contains a plurality of ball bearings 74. Any suitable ball bearing assembly is contemplated for use in the invention, so long as it is comprised of the three sections described herein and has the dimensions described above. The rotatable platform 24 is attached to the rotatable outer section 34 of the ball bearing assembly 30 with a plurality of outer section screws 36. The stationary inner section 32 of the ball bearing assembly 30 is attached to the base 12 with a plurality of inner section screws 37.

In accordance with the invention, the base may be rectangular, square or circular. In an embodiment, the base is square and has a width and length ranging from about 16 inches to about 36 inches. In an embodiment, the width and the length of the base are about 24 inches. In another embodiment, the base is rectangular and has a width ranging from about 16 inches to about 36 inches and a length ranging from about 18 inches to about 40 inches. In an embodiment, the width of the base is about 24 inches and the length of the base is about 26 inches. In another embodiment, the base is circular and has a diameter ranging from about 16 inches to about 36 inches. In an embodiment, the diameter of the base is about 24 inches.

The rotatable platform has a diameter ranging from about 12 inches to about 24 inches. In an embodiment, the diameter of the upper plate of the rotatable platform is about 18 inches.

The ball bearing assembly has a diameter ranging from about 10 inches to about 22 inches. In an embodiment, the diameter of the ball bearing assembly is about 17.5 inches. The invention encompasses that the ball bearing assembly has a diameter that is less than the diameter or dimensions of the rotatable platform.

The hollow vertical pole has a length ranging from about 20 inches to about 40 inches. In an embodiment, the length of the pole is about 32 inches.

The inner section of the handlebar has a length ranging from about 6 inches to about 12 inches. In an embodiment, the length of the inner section of the handlebar is about 9 inches. The outer section of the handlebar has a length ranging from about 4 inches to about 10 inches. In an embodiment, the length of the outer section of the handlebar is about 8 inches. The center extension pole of the handlebar has a length ranging from about 8 inches to about 16 inches. In an embodiment, the length of the center extension pole is about 12 inches.

The hand grip opening in the base has a length ranging from about 3 inches to about 10 inches, and a width ranging from about 1.0 inch to about 5 inches. In an embodiment, the length of the hand grip opening is about 5 inches and the width of the hand grip opening is about 2.0 inches.

The base, rotatable platform, hollow vertical pole and handlebar with center extension pole may be manufactured from any suitable strong material, such as, without limitation, aluminum, steel, steel alloys, aluminum alloys and the like.

In use, the present invention provides a mobility device to easily and quickly transfer a physically challenged individual from one seat to another seat as well as to facilitate the transfer of the individual from a seat at one location to a seat at another location. Specifically, in an embodiment, an individual, such as a caregiver, rotates the rotatable platform so that the traction means is facing the physically challenged individual who initially is sitting or reclining on a seat, such as a chair, couch, recliner or bed. The rotatable platform is rotated by moving the handlebar either in a clockwise or counter-clockwise direction. The caregiver places the toggle clamp in a clamped, or closed, position, so that the rotatable platform is locked in place while the individual is being placed on the device. The individual places his/her feet on the traction means and his/her hands on the handlebar and raises his/herself up onto the rotatable platform and, if necessary, is assisted by the caregiver in being raised up so that the individual is standing on rotatable platform. The mobility device has a capacity to handle an individual weighing up to 500 pounds. To facilitate the transfer from the seat to the device, the individual may wear a strap, belt or harness on his/her waist or midsection that the caregiver pulls on to assist the individual in standing up from the seat. If necessary, the length of the handlebar is adjusted to a comfortable height for the individual. The toggle clamp then is placed in an unclamped, or open position, i.e., the spindle is released from the base, to unlock the rotatable platform. The rotatable platform then is rotated by the caregiver by moving the handlebar in a clockwise or counter-clockwise direction so that the individual is facing away from a second seat located adjacent to, i.e., in close proximity, to the first seat. The individual then lowers his/herself from the device onto the second seat or, if necessary, is assisted in being lowered onto the second seat by the caregiver.

In accordance with another embodiment of the invention, the mobility device allows for easy and fast transfer of an individual from a first location to a second location. Specifically, and as an unlimited example, the individual may be seated on a chair in a living room (first seat and first location) and needs to be transferred to a bed in a bedroom (second seat and second location). The rotatable platform is rotated by the caregiver so that the traction section and handlebars are facing towards the individual. The toggle clamp then is placed in the clamped position. The individual places his/her feet on the traction means and his/her hands on the handlebar raises his/herself up onto the rotatable platform and, if necessary, is assisted by the caregiver in being raised up so that the individual is standing on rotatable platform. The toggle clamp then is placed in an unclamped position. The rotatable platform then is rotated by the caregiver by moving the handlebar so that the individual is facing away from a wheelchair located adjacent to the first seat. The individual then lowers his/herself from the device onto the wheelchair and, if necessary, is assisted in being lowered onto the wheelchair by the caregiver. The individual is moved, either by his/herself or by a caregiver, using the wheelchair, to the second location and adjacent to the bed. In order to move the mobility device to the other location, the toggle clamp is placed in the clamped position and the caregiver moves the mobility device from the first location to the second location by placing one hand through the hand grip opening in the base of the device, lifting up the base and then wheeling the device to the second location and adjacent to the wheelchair. The individual is raised from the seat of the wheelchair onto the traction means of the rotatable platform of the device. The toggle clamp is unclamped, and the rotatable platform is rotated so that the individual is facing away from the bed. The individual then lowers his/herself onto the bed or, if necessary, is assisted in by the caregiver in being lowered onto the bed.

It will be appreciated by those skilled in the art that changes could be made to the embodiments described above without departing from the broad inventive concept thereof. It is understood, therefore, that this invention is not limited to the particular embodiments disclosed, but it is intended to cover modifications that are within the spirit and scope of the invention, as defined by the appended claims.

What is claimed is:

1. A mobility device for transferring a physically challenged individual from one location to another location, comprising:
a base having a first end and a second end;
a ball bearing assembly positioned atop the base, said ball bearing assembly comprised of a stationary section, a rotatable section and a middle section, said middle section containing a plurality of ball bearing therein, said stationary section attached to the base;
a rotatable platform positioned atop the ball bearing assembly, said rotatable platform attached to the rotatable section of the ball bearing assembly;
a flange positioned atop the rotatable platform and located at one end of the rotatable platform;
a toggle clamp positioned atop the rotatable platform and located adjacent to the flange;
a hollow vertical pole having a first end and a second end, said second end of the hollow vertical pole configured to fit into the flange; and
a horizontal handlebar having a center extension pole, said center extension pole configured to fit into the first end of the hollow vertical pole.

2. The mobility device of claim 1, wherein the rotatable platform contains a plurality of traction means located at an opposite end from the flange and the toggle clamp.

3. The mobility device of claim 1, wherein the base contains a hand grip opening adjacent to the first end of the base, said hand grip opening configured to accept fingers of a user therein to allow the user to raise up the first end of the base when transporting the device from one location to another.

4. The mobility device of claim 1, wherein the base includes a plurality of wheels attached to the second end of the base.

5. The mobility device of claim 1, wherein the flange has a flange knob with a threaded stud inserted on its surface, wherein when the flange knob is tightened, the hollow vertical pole is secured in the flange.

6. The mobility device of claim 1, wherein the center extension pole may be moved upwardly or downwardly to raise or lower the handlebar to a desired height.

7. The mobility device of claim 1, wherein the hollow vertical pole has two pole knobs with a threaded stud inserted on its surface, wherein when the pole knobs are tightened, the center extension pole is secured in the hollow vertical pole.

8. The mobility device of claim 1, wherein the hollow vertical pole has a plurality of openings on its surface, and the center extension pole has a plurality of openings on its surface, wherein when an opening on the hollow vertical pole is aligned with an opening on the center extension pole, and a metal fastener pin in inserted through the aligned openings, the center extension pole is secured tightly in the hollow vertical pole.

9. The mobility device of claim 1, wherein the toggle clamp is comprised of an arm, a handle and a spindle, wherein when the toggle clamp is in a clamped position, the spindle is pressed tightly atop the base to lock the rotatable platform in place to prevent its rotation.

10. The mobility device of claim 1, wherein the base is square-shaped, rectangular-shaped or circular.

11. The mobility device of claim 1, wherein the rotatable platform is circular in shape.

12. The mobility device of claim 1, wherein the ball bearing assembly is circular in shape and has a diameter that is less than the diameter of the rotatable platform.

13. The mobility device of claim 1, wherein two wheels are attached to the second end of the base.

14. The mobility device of claim 1, wherein the individual wears a strap, belt or harness on his/her waist or midsection that a second individual can pull on in order to allow the second individual to raise up the individual from a seat.

15. A method of transferring a physically challenged individual from one seat to another seat using the mobility device of claim 1, the method comprising:
rotating the rotatable platform so that the traction means is facing towards an individual sitting or reclining on a first seat;
placing the toggle clamp in a clamped position to lock the rotatable platform in place;
placing each foot of the individual on the traction means of the rotatable platform;
placing each hand of the individual on the horizontal handlebar;
raising the individual up from the first seat or the bed;
placing the toggle clamp in an unclamped position to unlock the rotatable platform so that it is able to rotate;
rotating the rotatable platform so that the individual is facing away from a second seat located adjacent to the first seat; and
lowering the individual onto the second seat.

16. The method of claim 15, wherein the second seat is a wheelchair.

17. The method of claim 15, wherein the rotatable platform is rotated by rotating the handlebar clockwise or counter-clockwise.

18. A method of transferring a physically challenged individual from one or more seats at one location to one or more seats in another location using the mobility device of claim 1, the method comprising:
rotating the rotatable platform so that the traction means is facing towards an individual sitting or reclining on the first seat located at a first location;
placing the toggle clamp in the clamped position to lock the rotatable platform in place;
placing each foot of the individual on the traction means of the rotatable platform;
placing each hand of the individual on the horizontal handlebar;
raising the individual up from the first seat or the bed;
placing the toggle clamp in an unclamped position to unlock the rotatable platform so that it is able to rotate;
rotating the rotatable platform so that the individual is facing away from a seat of an ambulatory device;
lowering the individual onto the seat of the ambulatory device;
moving the individual adjacent to a second seat located at a second location using the ambulatory device;
placing the toggle clamp in a clamped position to lock the rotatable platform in place;
having a second individual move the device from the first location to the second location and positioning the device adjacent to the ambulatory device;
placing each foot of the individual on the traction means of the rotatable platform;
placing each hand of the individual on the horizontal handlebar;
raising the individual from the seat of the wheelchair;
placing the toggle clamp in an unclamped position to unlock the rotatable platform so that it is able to rotate;
rotating the rotatable platform so that the individual is facing away from the second seat; and
lowering the individual from the rotatable platform onto the second seat.

19. The method of claim 18, wherein the rotatable platform is rotated by rotating the handlebar clockwise or counter-clockwise.

20. The method of claim 18, wherein the second individual places his/her fingers in the hand grip opening in order to raise up the first end of the base, wherein the second individual moves the device by wheeling the device from the first location to the second location.
